(19) United States
(12) Patent Application Publication
(10) Pub. No.: US 2017/0162229 A1
(43) Pub. Date: Jun. 8, 2017

(54) PLAY METHOD AND DEVICE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Hong CAO, Tianjin (CN); Jijian ZHENG, Tianjin (CN); Jianyong CUI, Tianjin (CN)

(21) Appl. No.: 15/246,367

(22) Filed: Aug. 24, 2016

Related U.S. Application Data
(63) Continuation of application No. PCT/CN2016/089243, filed on Jul. 7, 2016.

(30) Foreign Application Priority Data
Dec. 3, 2015 (CN) 201510883359.2

(51) Int. Cl. G11B 27/19; H04N 21/64; H04N 21/2387

(52) U.S. Cl. CPC G11B 27/19; H04N 21/2387; H04N 21/64

(57) ABSTRACT

An embodiment of the present disclosure discloses a play method and device, wherein the method specifically comprises the steps of a player receiving a calling request from an application, wherein the calling request comprises the address parameter of multi-media contents and the position parameter of the multi-media contents; the player acquiring the multi-media contents starting from a target position corresponding to the position parameter from a server according to the address parameter; and the player playing the multi-media contents starting from the target position. The embodiment of the present disclosure may improve the efficiency of playing multi-media contents from the target position for the first time, and save memory space of an information device.

### CROSS-REFERENCE TO RELATED APPLICATIONS

This application is a continuation of International Application No. PCT/CN2016/089243 filed on Jul. 7, 2016, which is based upon and claims priority to Chinese Patent Application No. 201510883359.2, entitled “PLAY METHOD AND DEVICE”, filed Dec. 3, 2015, the entire contents of all of which are incorporated herein by reference.

### FIELD OF TECHNOLOGY

The disclosure relates to the technical field of multi-media, in particular to a play method and device.

### BACKGROUND

Along with continuous development of multi-media technology, watching videos or playing music on the Internet becomes more and more convenient. Users may acquire multi-media contents, for example, watch TV series, movies and some fantastic videos and play favorite music, on the Internet by using terminal devices like mobile phones and smart TVs.

In the process of implementing the present disclosure, the inventor found that, at present, TV series, movies, fantastic videos, etc. all have undesirable segments at the beginning. Therefore, the current solution may support the function of skipping over the titles so that users may directly skip over the titles of a TV series by settings to obtain uninterrupted play of the TV series.

According to an Android-system-based solution for skipping over the titles, a bottom player of an operating system supplies an interface to an application, and the application calls the interface to realize the function of skipping over the titles. Specifically, the application may call an interface 1 to inform the bottom layer to download a video file from a server and prepare the video file, and when the bottom player begins to play the preparations of the video file, according to the settings of skipping over the titles sent by the user, calls an interface 2 to inform the bottom layer to play the video file from the position next to the titles.

However, under the conditions that the user sends a command of skipping over the titles, the contents of the titles are useless for the user, so the downloading and preparation of the contents of the titles tend to cause processing time redundancy and memory space redundancy.

### SUMMARY

An embodiment of the present disclosure discloses a play method and device for overcoming the defects of processing time redundancy and memory space redundancy easily caused by the downloading and preparations of the contents of the titles in the prior art, capable of improving the efficiency of playing multi-media contents from the target position for the first time, and capable of saving memory space of an information device.

An embodiment of the present disclosure discloses a play method, including: a player receiving a calling request from an application, wherein the calling request comprises the address parameter of multi-media contents and the position parameter of the multi-media contents; the player acquiring the multi-media contents starting from a target position corresponding to the position parameter from a server according to the address parameter; and the player playing the multi-media contents starting from the target position.

An embodiment of the present disclosure discloses a play device, including at least one processor; and a memory communicably connected with the at least one processor for storing instructions executable by the at least one processor, wherein execution of the instructions by the at least one processor causes the at least one processor to: receive a calling request from an application, wherein the calling request comprises the address parameter of multi-media contents and the position parameter of the multi-media contents, acquire the multi-media contents starting from a target position corresponding to the position parameter from a server according to the address parameter; play the multi-media contents starting from the target position.

An embodiment of the present disclosure discloses a non-transitory computer readable medium storing executable instructions that, when executed by an electronic device, cause the electronic device to: receive a calling request from an application, wherein the calling request comprises the address parameter of multi-media contents and the position parameter of the multi-media contents; acquire the multi-media contents starting from a target position corresponding to the position parameter from a server according to the address parameter; and play the multi-media contents starting from the target position.

Through the play method and device according to the embodiment of the present disclosure, the application may transmit the address parameter of multi-media contents and the position parameter of the multi-media contents to a player via interfaces at the same time, so the player acquires the multi-media contents starting from a target position corresponding to the position parameter from the server according to the address parameter. The embodiment of the present disclosure may merely acquire the multi-media contents starting from the target position and may prepare the multi-media contents starting from the target position before playing the multi-media contents starting from the target position, so compared with the existing solution in which the downloading and preparations of the contents of the titles tend to cause processing time redundancy and memory space redundancy, the embodiment of the present disclosure may improve the efficiency of playing the multi-media contents from the target position for the first time, and may save memory space of the information device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a play method in accordance with some embodiments.

FIG. 2 is a step flowchart of a play method in accordance with some embodiments.

FIG. 3 is a step flowchart of a play method in accordance with some embodiments.

FIG. 4 is a step flowchart of a play method in accordance with some embodiments.

FIG. 5 is a structural block diagram of a play device in accordance with some embodiments.

FIG. 6 schematically illustrates a block diagram of an electronic device for executing steps of the method in accordance with some embodiments.

### DETAILED DESCRIPTION

To clarify the objectives, technical solutions and advantage of the embodiments of the present disclosure, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, a person skilled in the art may obtain other embodiments without creative labor, which shall all fall within the protection scope of the present disclosure.

### Method Embodiment 1

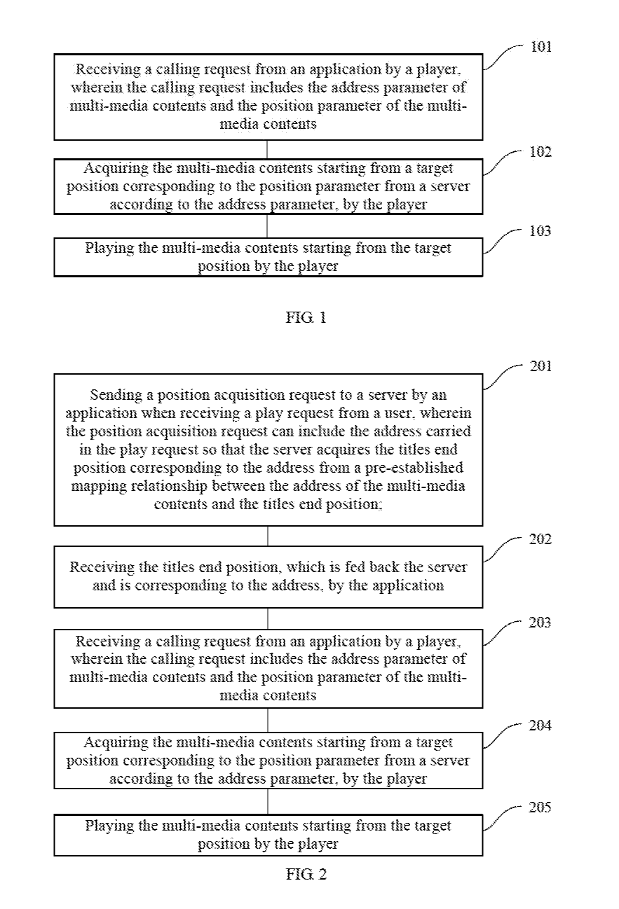

Refer to FIG. 1, which illustrates a step flowchart of a play method according to a first embodiment of the present disclosure. The method may specifically include the steps as follows.

Step 101: A player receives a calling request from an application, wherein the calling request may specifically include the address parameter of multi-media contents and the position parameter of the multi-media contents.

Step 102: The player acquires the multi-media contents starting from a target position corresponding to the position parameter from a server according to the address parameter.

Step 103: The player plays the multi-media contents starting from the target position.

The embodiment of the present disclosure may be applied to information devices with independent operating systems such as smart TVs, mobile phones, tablet computers, etc., to efficiently play the multi-media contents starting from the target position for the first time, and to saving the memory space of the information devices. The embodiment of the present disclosure mainly takes the information devices with Android system as an example for description, and the information devices with Android system may be reference of information devices with other operating systems such as IOS.

For the android system, the mode of processing the multi-media contents is usually as follows. A bottom layer of an operating system supplies interfaces to an application, and the application calls the interfaces to realize the function of skipping over the titles. The application is usually developed according to the interfaces, so once the interfaces change, the problem of compatibility between the interface and the application tend to occur, which means that the application tend to be abnormal. This factor basically limits changes, to the interfaces and to the Android-system-based solutions for skipping over the titles, made by a person skilled in the art.

The embodiment of the present disclosure creatively puts forward a play solution for playing the multi-media contents from the target position for the first time. The play solution may make an improvement with little to the interfaces. Specifically, relative to the existing solution the address parameter of the multi-media contents is transmitted to the player merely via the interfaces. The embodiment of the present disclosure may transmit the address parameter of multi-media contents and the position parameter of the multi-media contents to the player via the interfaces at the same time, so the player acquires the multi-media contents starting from a target position corresponding to the position parameter from the server according to the address parameter. The embodiment of the present disclosure may merely acquire the multi-media contents starting from the target position and may prepare the multi-media contents starting from the target position before playing the multi-media contents starting from the target position, so compared with the existing solution in which the downloading and preparations of the contents of the titles tend to cause processing time redundancy and memory space redundancy, the embodiment of the present disclosure may improve the efficiency of playing the multi-media contents from the target position for the first time, and may save memory space of the information device.

What should be noted is that, the improvement on the interface according to the embodiment of the present disclosure specifically includes: the application transmits the address parameter of the multi-media contents and the position parameter of the multi-media contents to the player via at the interfaces at the same time, so the change to the interfaces is little, which means that, the change basically does not affect the compatibility between the interfaces and the application, may avoid the application from being abnormal, and therefore may ensure the stability of the application.

In the embodiment of the present disclosure, APP (Application) may be used for representing applications which are installed in information devices, nm in the user mode, may interact with users, and have visible user interfaces, for example Sohu Player APP and Letv APP. Specifically, the application may receive a play request from a user. The play request may carry address of the multi-media contents, for example URL (Uniform Resource Locator), etc. In this way, after receiving the request user of the user, the application may call the interfaces supplied by the player to transmit the address parameters of the multi-media contents and the position parameters of the multi-media contents to the player.

In this embodiment of the present disclosure, the multi-media contents may specifically include: any one or combinations of pictures, characters, videos and audios. The multi-media contents may be transmitted in a format of streaming media. The streaming media may comply with the HLS (HTTP Live Streaming) protocol. The embodiment of the present disclosure does not limit specific multi-media contents and transmission protocol thereof.

In this embodiment of the present disclosure, the position parameter of the multi-media contents practically is as follows: when the multi-media contents corresponding to the address parameter are requested from the server, the position parameter is transmitted to the server so that the server acquires the multi-media contents corresponding to the target position. In an optional embodiment of the present disclosure, the process that the player acquires the multi-media contents starting from the target position corresponding to the position parameter from the server according to the address parameter may specifically include: the player downloads the multi-media contents staring from the target position corresponding to the position parameter according to the address parameter. Provided that the multi-media contents comply with the HLS protocol, the downloading processing may specifically include: downloading an index file of the multi-media contents from the server, analyzing the index file of the multi-media contents to obtain the downloading address of a segment of the multi-media contents, and downloading the segment in the multi-media contents according to the downloading address of the segment.

In an application example of the present disclosure, the index file may be an M3U8 file. The M3U8 file refers to an M3U file in a coding format of UTF-8 (8-bit Unicode Transformation Forma), wherein M3U is a list file of audio files. After M3U file is downloaded, it may be not directly played. The M3U file is used to find out a network address to perform on-line play; usually, M3U file is very small, because of any audio data therein, which means that M3U file is a directory file, providing an index pointing out the audio and video files at other positions.

In another embodiment of the present disclosure, the step that the player plays the multi-media contents from the target position may specifically include: preparing to play the multi-media contents from the target position first, and then playing the prepared multi-media contents. Wherein, the process of preparing to play the multi-media contents from the target position may specifically include: separating audio contents and video contents in the multi-media contents from the target position, respectively decoding the audio contents and the video contents, wherein the decoded audio contents and video contents may be cached into a corresponding buffer area, and then in the process of playing the prepared multi-media contents, the corresponding audio contents and video contents may be directly read from the buffer area, thus improving the playing fluency.

In actual application, the target position according to the embodiment of the present disclosure may specifically include: titles end position, end position of the last played multi-media contents, preset position, etc. Wherein, the titles end position may be used for realizing the function of skipping over the titles of the TV series; the end position of the last played multi-media contents may be used for realizing the connection play function, and the preset position may be used for realizing the function of first play of any position designed by the user. It is understandable that, different multi-media contents may have identical or different target positions, for example, different episodes of the same TV series may have identical target positions, while the different episodes of the TV series may have different target positions; for another example, if a certain episode is turned off halfway the connection play function may be conducted through the end position of the last played multi-media contents. It is understandable that, the embodiment of the present disclosure does not limit the specific target position.

In an optional embodiment of the present disclosure, when the play method applies to the Android system, the step of receiving the calling request from the application may specifically include:

step S1: receiving a serialized object from the application;

step S2: analyzing the serialized object to obtain the address parameter of the multi-media contents and the position parameter of the multi-media contents.

Through the optional embodiment, the address parameter of the multi-media contents and the position parameter of the multi-media contents may be transmitted in form of the serialized object, thereby ensuring the security of the address parameter of the multi-media contents and the position parameter of the multi-media contents during the transmission.

For the Android system, the serialized object may specifically include: Parcelable type serialized objects and Serializable type serialized objects. Providing that a List variable is used to describe the position parameter, the application may convert the List variable into the Serializable type, and then transmits the converted result to the player by means of putExtras(key, (Serializable)list), while the player may receive the List variable through (List<YourObject>) getIntent( ).getSerializable(key). It is understandable that, the embodiment of the present disclosure does not limit the specific transmission process of the address parameter of the multi-media contents and the position parameter of the multi-media contents during the transmission.

In conclusion, the embodiment of the present disclosure may merely acquire the multi-media contents starting from the target position and may prepare the multi-media contents starting from the target position before playing the multi-media contents starting from the target position, so compared with the existing solution in which the downloading and preparations of the contents of the titles tend to cause processing time redundancy and memory space redundancy, the embodiment of the present disclosure may improve the efficiency of playing the multi-media contents from the target position for the first time, and may save memory space of the information device.

### Method Embodiment 2

Refer to FIG. 2, which illustrates a step flowchart of a play method according to a second embodiment of the present disclosure. The method may specifically include the steps as follows.

Step 201: An application sends a position acquisition request to a server when receiving a play request from a user, wherein the position acquisition request may include the address carried in the play request so that the server acquires the titles end position corresponding to the address from a pre-established mapping relationship between the address of the multi-media contents and the titles end position.

Step 202: The application receives the titles end position, which is fed back the server and is corresponding to the address.

Step 203: A player receives a calling request from an application, wherein the calling request may specifically include the address parameter of multi-media contents and the position parameter of the multi-media contents.

Step 204: The player acquires the multi-media contents starting from a target position corresponding to the position parameter from a server according to the address parameter.

Step 205: The player plays the multi-media contents starting from the target position.

Relative to the first method embodiment, in this embodiment, the process that the application acquires the titles end position corresponding to the address from the server according to the user's play request. Wherein, the server may acquire the titles end position corresponding to the address from the pre-established mapping relationship between the address of the multi-media contents and the titles end position to improve the efficiency of acquiring the titles end position.

It is understandable that, in other embodiments of the present disclosure, without the pre-established mapping relationship, the server may also acquire the titles end position corresponding to the address on line. The embodiment of the present disclosure does not limit the specific acquisition process of the titles end position.

### Method Embodiment 3

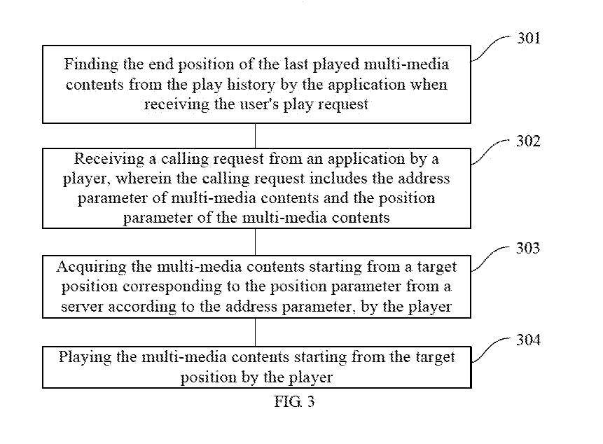

Refer to FIG. 3, which illustrates a step flowchart of a play method according to a third embodiment of the present disclosure. The method may specifically include the steps as follows.

Step 301: An application finds the end position of the last played multi-media contents from the play history when receiving the user's play request.

Step 302: A player receives a calling request from an application, wherein the calling request may specifically include the address parameter of multi-media contents and the position parameter of the multi-media contents.

Step 303: The player acquires the multi-media contents starting from a target position corresponding to the position parameter from a server according to the address parameter.

Step 304: The player plays the multi-media contents starting from the target position.

Relative to the first method embodiment, in this embodiment, the process that the application finds the end position of the last played multi-media contents from the play history when receiving the user's play request is added, wherein the application may record the address information and end position information of the multi-media contents in the play history under the condition that the multi-media contents is turned off before being finished. It is understandable that, the embodiment of the present disclosure does not limit the specific acquisition method of the end position of the last played multi-media contents.

### Method Embodiment 4

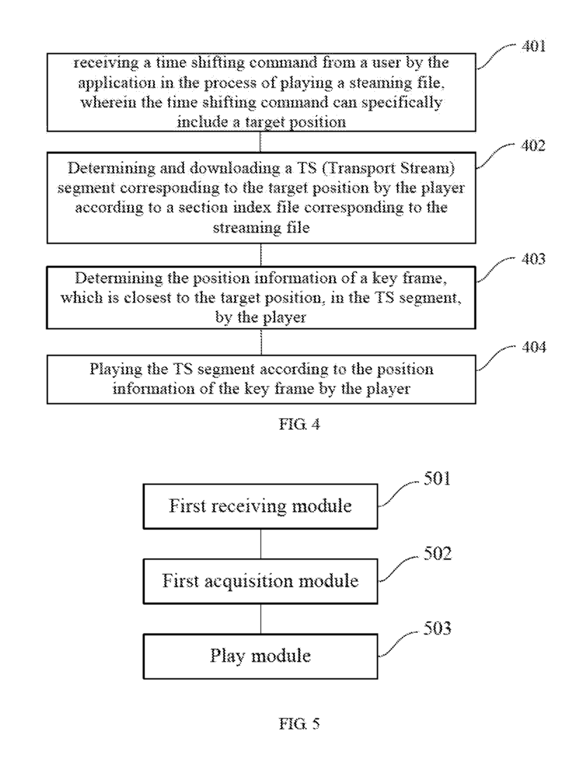

Refer to FIG. 4, which illustrates a step flowchart of a play method according to a fourth embodiment of the present disclosure. The method may specifically include the following steps.

Step 401: An application receives a time shifting command from a user in the process of playing a steaming file, wherein the time shifting command may specifically include a target position.

Step 402: A player determines and downloads a TS (Transport Stream) segment corresponding to the target position according to a segment index file according to the streaming file.

Step 403: The player determines the position information of a key frame, which is closest to the target position, in the TS segment.

Step 404: The player plays the TS segment according to the position information of the key frame.

Relative to the first method embodiment, the target position of the embodiment may also be the position determined by the user according to the play progress bar. Taking a TV series with a time length of 40 min as an example, a user may drag the play progress bar to the 25 min position, and then the player requests the server for the TS segment corresponding to the 25the minute point. The HLS takes segment as the transport unit, so the server in the prior art feeds the segment starting from the 20 min position to a terminal device, and the player plays the TV series from the 20th minute position. Therefore, there is a certain error in the prior art, and accurate time shifting cannot be achieved.

The embodiment may determine the corresponding TS segment and the position information of the key frame, which the closest to the time shifting point, in the TS segment, thereby directly playing the TS segment from the position information. Relative to the prior art in which the play starts from the head of the segment, the embodiment of the present disclosure may directly play the TS segment from the key frame which is closest to the time shifting position, and therefore may improve the time shifting accuracy in the process of playing the streaming file. Besides, through the embodiment of the present disclosure, the key frame closest to the target position may be directly positioned. The key frame may be independently decoded to play, and it is not needed to decode from the beginning of the TS segment, thus improving the decoding efficiency.

According to the HLS protocol, the steaming file consists of a plurality of TS segments according to the time sequence, and the index file of the segment may record the sequence and the time length of every TS segment. The total time length of the streaming file and the time length of every TS segment may be acquired through the index file. Usually, the time length of the TS segment is fixed or equivalent, so the TS segment corresponding to the target position may be determined according to the total time length of the streaming file and the time length of every TS segment.

According to an optimal embodiment of the present disclosure, the segment index file may include the time length information of the TS segment.

The step of determining the TS segment corresponding to the time shifting point according to the segment index file may specifically include: determining the beginning time information of the TS segment according to the time length information of the TS segment, and determining the TS segment corresponding to the time shifting point according to the starting time information of the TS segment.

Specifically, the following is an index file taken as an example to describe process of determining the TS segment corresponding to the target position.

#EXTM3U
#EXT-X-TARGETDURATION:10
#EXT-X-MEDIA-SEQUENCE:0
#EXTINF:10,
https://priv.example.com/fileSequence0.ts
#EXTINF:10,
https://priv.example.com/fileSequence1.ts
#EXTINF:10,
https://priv.example.com/fileSequence2.ts

Wherein, EXTM3U is a file header, used as a mark; EXT-X-VERSION represents the protocol version; EXT-X-TARGETDURATION represents the maximum time length of every TS segment; EXT-X-MEDIA-SEQUENCE represents the serial number of the first TS segment in the current index file, and every TS segment has an exclusive fixed serial number in the index file; EXTINF represents the time length information of the TS segment; https://priv.example.com/fileSequence0.ts represents the URL (Uniform Resource Locator) corresponding to the TS segment with a serial number of 0; and the above mentioned index file includes three TS segments, with serial numbers 0, 1, 2 respectively.

In the above application example, the time length of every TS segment is 10 s, and then the starting time of every TS segment may be calculated, for example, the starting time of the first TS segment is 0 s; the starting time of the second TS segment is 10 s; the starting time of the third TS segment is 30 s. Providing that the target position is 25 s, it may be determined that the target position is in the second TS segment.

In a specific application, the video file is comprised of a frame I (key frame), a frame P, frame B, etc. It is needed to decode the video frames before playing a video, and only the frame I may be independently decoded and play. When the data frame corresponding to the target position requested by the user is not the frame I, then play fails. Therefore, it is needed to determine the position information of the frame I, which is closest to the target position, in the TS segment.

In order to quickly position the frame I closest to the target position, in this embodiment of the present disclosure, when the server segments the streaming file and generates the index file, except recording the time length information of the segment, the starting time information and offset information of all frames I may be stored in the index file. The player may obtain the starting time information and offset information of the frame I in every TS segment in the process of analyzing the index file. Correspondingly, the step of the player determining the position information of the key frame, which is closest to the target position, in the TS segment may specifically include the following sub-steps: the player analyzes the segment index file and obtains the starting time information and offset information of all key frames in the TS segment; and the player determines the starting time information and the offset information of the key frame which is closest to the target position.

In an application example of the present disclosure, a terminal device decodes and plays the streaming file. In the process of analyzing the m3u8 index file, when the analysis reaches the #EXT-X-STREAM-INF:KEYFRAME field, the starting time information and offset information corresponding to every frame I may be stored in a data list, and every TS segment corresponds to a list, so the position of the frame I may be quickly positioned during the time shifting operation without analyzing the m3u8 index file each time when the time shifting is executed, thus improving the time shifting efficiency. When the user carries out the time shifting operation, the TS segment corresponding to the target time point is found according to the target time point of the time shifting carried out by the user and according to the m3u8 index file, and then the list corresponding to the segment is found out; the starting time information and offset information of the closest frame I are found; then, the streaming file may be played from the position of the frame I.

In an application example of the present disclosure, an extension field “KEYFRAME” is added behind the description field “EXTINF” of each segment of the index file to define the starting time information and offset information of the frame I. Specifically, refer to the following application example of an index file of the present disclosure.

#EXTM3U
#EXT-X-VERSION:3
#EXT-X-TARGETDURATION: 10
#EXT-X-MEDIA-SEQUENCE:0
#EXTINF:10,
#EXT-X-STREAM-INF:KEYFRAME=”0,56;3.32,153224;5.94, 683546”
https://priv.example.com/fileSequence0.ts
#EXTINF:10,
#EXT-X-STREAM-INF:KEYFRAME=”0,72;4.89,124532;6.82,356820”
https://priv.example.com/fileSequence1.ts

Wherein, KEYFRAME is an extension file defined by the embodiment of the present disclosure, used for marking the starting time information and offset information of the frame I, for example, it is defined that KEYFRAME=“time, offset, time, offset; . . . ”, wherein time is the starting time of the frame I, and offset represents the offset information. In the above example, the TS segment with a serial number of 0 includes three frames I; the starting time of the first frame I is 0 s, and the offset is 56; the starting time is 4.89 s, and the offset is 124532; the starting time of the third frame I is 6.82 s, and the offset is 356820.

Through the play method according to the embodiment of the present disclosure, the application may transmit the address parameter of multi-media contents and the position parameter of the multi-media contents to a player via interfaces at the same time, so the player acquires the multi-media contents starting from a target position corresponding to the position parameter from the server according to the address parameter. The target position of the embodiment may be the position determined the user according to the play progress bar. The embodiment of the present disclosure can merely acquire the multi-media contents starting from the target position and can prepare the multi-media contents starting from the target position before playing the multi-media contents starting from the target position, so compared with the existing solution in which the downloading and preparations of the contents of the titles tend to cause processing time redundancy and memory space redundancy, the embodiment of the present disclosure can improve the efficiency of playing the multi-media contents from the target position for the first time, and can save memory space of the information device.

It is needed to be noted that, for simple description, the method embodiments are described as a series of action combinations, but a person skilled in the art understands that the embodiments of the present disclosure are not limited by the sequence of the described actions because according to the embodiments of the present disclosure, some steps may be implemented in other sequence or at the same time. Moreover, a person skilled in the art also should understand that the embodiments described in the present disclosure all belong to optimal embodiments, and some actions involved are not always needed by the embodiments of the present disclosure.

### Device Embodiment

Refer to FIG. 5, which illustrates a structural block diagram of a play device according to an embodiment of the present disclosure. The device may specifically include:

a first receiving module 501, positioned in a player, used for receiving a calling request from an application, wherein the calling request may specifically include the address parameter of multi-media contents and the position parameter of the multi-media contents;

a first acquisition module 502, positioned in the player, used for acquiring the multi-media contents starting from a target position corresponding to the position parameter from a server according to the address parameter; and,

a play module 503, positioned in the player, used for playing the multi-media contents starting from the target position.

According to an optional embodiment of the present disclosure, the target position may specifically include a titles end position, and the device may also include:

a second acquisition module, positioned in the application, used for sending a position acquisition request to a server when receiving a play request from a user, wherein the position acquisition request may include the address carried in the play request so that the server acquires the titles end position corresponding to the address from a pre-established mapping relationship between the address of the multi-media contents and the titles end position;

and a second receiving module, positioned in the application, used for receiving the titles end position which is fed back the server and is corresponding to the address.

In another optional embodiment of the present disclosure, the target position may specifically include: end position of the last played multi-media contents, and the device may also include:

a search module, positioned in the application, used for finding the end position of the last played multi-media contents from the play history when receiving the user's play request.

In another optional embodiment of the present disclosure, the multi-media contents may specifically include a streaming file, and the device may also include:

a third receiving module, positioned in the application, used for receiving a time shifting command from a user in the process of playing a steaming file, wherein the time shifting command may specifically include a target position.

The first acquisition module 501 may specifically include:

a downloading sub-module, used for determining and downloading a TS segment corresponding to the target position according to a segment index file according to the streaming file.

The play module 503 may specifically include:

a determination sub-module, used for determining the position information of a key frame, which is closest to the target position, in the TS segment; and

a play sub-module, used for playing the TS segment according to the position information of the key frame.

According to another optional embodiment of the present disclosure, the determination submodule may specifically include:

an analysis unit, used for analyzing the segment index file and obtaining the starting time information and offset information of all key frames in the TS segment; and

a determination unit, used for determining the starting time information and offset information corresponding to the key frame closest to the target position.

According to an optional embodiment of the present disclosure, the device may apply to an Android system, and then the first receiving module 501 may specifically include:

an object receiving sub-module, used for receiving a serialized object from the application; and

an analysis sub-module, used for analyzing the serialized object to obtain the address parameter of the multi-media contents and the position parameter of the multi-media contents.

The device embodiment is basically the same as the method embodiments and therefore is simply described. Related contents may be seen in the related description of the method embodiments.

Through the play device according to the embodiment of the present disclosure, the application may transmit the address parameter of multi-media contents and the position parameter of the multi-media contents to a player via interfaces at the same time, so the player acquires the multi-media contents starting from a target position corresponding to the position parameter from the server according to the address parameter. The embodiment of the present disclosure may merely acquire the multi-media contents starting from the target position and may prepare the multi-media contents starting from the target position before playing the multi-media contents starting from the target position, so compared with the existing solution in which the downloading and preparations of the contents of the titles tend to cause processing time redundancy and memory space redundancy, the embodiment of the present disclosure may improve the efficiency of playing the multi-media contents from the target position for the first time, and may save memory space of the information device.

The device embodiment described above is merely schematic, wherein units described as separable parts may be or may be not physically separated, and components displayed as units may be or may be not physical units, which means that the units may be positioned at one place or distributed on a plurality of network units. Some or all modules may be selected to fulfill the objective of the solution in the embodiment upon actual demands. A person skilled in the art may understand and implement the present disclosure without creative work.

Through the description of the above embodiments, a person skilled in the art may clearly know that the embodiments may be implemented by software and necessary universal hardware platforms, or by hardware. Based on this understanding, the above solutions or contributions thereof to the prior art may be reflected in form of software products, and the computer software products may be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Embodiments of the present disclosure further provide a non-volatile computer-readable storage medium, the non-volatile computer-readable storage medium is stored with computer executable instructions which are configured to perform any of the embodiments described above of the play method.

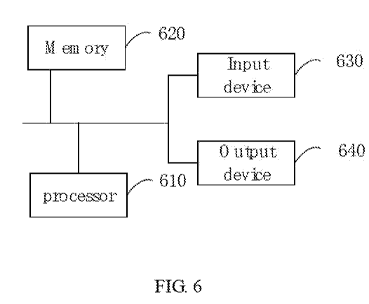

FIG. 6 illustrates a block diagram of an electronic device for executing the method according the disclosure, such as an application server. As shown in FIG. 6, the electronic device includes:

one or more processors 610 and memories 620, in FIG. 6, one processor 610 is taken as an example.

The electronic device for executing the play method may include: an input device 630 and an output device 640.

The processor 610, the memory 620, the input device 630 and the output device 640 are connected through buses or other connecting ways. In FIG. 6, a bus connection is taken as an example.

The memory 620 is a non-transitory computer readable storage medium which may be used to store non-transitory software program, non-transitory computer-executable program and modules such as the program instructions/modules (such as the first receiving module 501, the first acquisition module 502 and the play module 503 shown in FIG. 5) corresponding to the play method according to the embodiment of the present disclosure. The processor 610 executes various functions and applications of the electronic device and performs data processing by operating the non-transitory software programs, instructions and modules stored in the memory 620, that is, executes the play method according to the method embodiments above.

The memory 620 may include a program storage section and a data storage section. Wherein the program storage section may store operating system and application needed by at least one function, and the data storage section may store the established data according to the device for adjusting the video. In addition, the memory 620 may include a high-speed random access memory, and may also include a non-transitory memory such as at least a disk memory device, flash memory device or other non-transitory solid-state storage devices. In some embodiments, the memory 620 may include a remote memory away from the processor 610. The remote memory may be connected to the device for adjusting the video via network. The network herein may include Internet, interior network in a company, local area network, mobile communication network and the combinations thereof.

The input device 630 may receive input numbers or characteristics information, and generate key signal input relative to the user setting and function control of the device for adjusting the video. The output device 640 may include display devices such as a screen.

The one or more modules are stored in the memory 620, when executed by the one or more processors 610, the play method in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices:

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A play method, comprising:
at an electronic device:
a player receiving a calling request from an application, wherein the calling request comprises the address parameter of multi-media contents and the position parameter of the multi-media contents;
the player acquiring the multi-media contents starting from a target position corresponding to the position parameter from a server according to the address parameter;
and the player playing the multi-media contents starting from the target position.

2. The method according to claim 1, wherein the target position comprises a titles end position, and the method further comprises:
an application sending a position acquisition request to a server when receiving a play request from a user, wherein the position acquisition request may comprise the address carried in the play request so that the server acquires the titles end position corresponding to the address from a pre-established mapping relationship between the address of the multi-media contents and the titles end position;
and the application receiving the titles end position which is fed back the server and is corresponding to the address.

3. The method according to claim 1, wherein the target position comprises an end position of the last played multi-media contents, and the method further comprises:
the application finding the end position of the last played multi-media contents from the play history when receiving the user's play request.

4. The method according to claim 1, wherein the multi-media contents comprise a steaming file, and the method further comprise:
the application receiving a time shifting command from a user in the process of playing a steaming file, wherein the time shifting command may specifically comprise a target position;
the step of the player acquiring the multi-media contents starting from a target position corresponding to the position parameter from a server according to the address parameter comprises:
the player determining and downloading a TS segment corresponding to the target position according to a segment index file according to a streaming file;
the step of the player playing the multi-media contents starting from the target position comprises:
the player determining the position information of a key frame, which is closest to the target position, in the TS segment;
and the player playing the TS segment according to the position information of the key frame.

5. The method according to claim 4, wherein the step of the player determining the position information of a key frame, which is closest to the target position, in the TS segment, comprises:
the player analyzing the segment index file and obtaining the starting time information and offset information of all key frames in the TS segment; and
the player determining the starting time information and offset information corresponding to the key frame closest to the target position.

6. The method according to claim 1, wherein the method applies to the Android system, and then the step of receiving the calling request from the application comprises:
receiving a serialized object from the application;
analyzing the serialized object to obtain the address parameter of the multi-media contents and the position parameter of the multi-media contents.

7. An electronic device, comprising:
at least one processor, and
a memory communicably connected with the at least one processor for storing instructions executable by the at least one processor, wherein execution of the instructions by the at least one processor causes the at least one processor to:
receive a calling request from an application, wherein the calling request comprises the address parameter of multi-media contents and the position parameter of the multi-media contents;
acquire the multi-media contents starting from a target position corresponding to the position parameter from a server according to the address parameter;
play the multi-media contents starting from the target position.

8. The electronic device according to claim 7, wherein the target position comprises a titles end position, and wherein execution of the instructions by the at least one processor causes the at least one processor to:
send a position acquisition request to a server when receiving a play request from a user, wherein the position acquisition request comprises the address carried in the play request so that the server acquires the titles end position corresponding to the address from a pre-established mapping relationship between the address of the multi-media contents and the titles end position;
receive the titles end position which is fed back the server and is corresponding to the address.

9. The electronic device according to claim 7, wherein the target position comprises an end position of the last played multi-media contents, and wherein execution of the instructions by the at least one processor causes the at least one processor to:
find the end position of the last played multi-media contents from the play history when receiving the user's play request.

10. The electronic device according to claim 7, wherein the multi-media contents comprise a steaming file, and wherein execution of the instructions by the at least one processor causes the at least one processor to:
receive a time shifting command from a user in the process of playing a steaming file, wherein the time shifting command comprises a target position;
acquire the multi-media contents starting from a target position corresponding to the position parameter from a server according to the address parameter comprises:
determining and downloading a TS segment corresponding to the target position according to a segment index file according to the streaming file.
play the multi-media contents starting from the target position comprises:
determining the position information of a key frame, which is closest to the target position, in the TS segment; and
playing the TS segment according to the position information of the key frame.

11. The electronic device according to claim 10, wherein determining the position information of a key frame, which is closest to the target position, in the TS segment, comprises:
analyzing the segment index file and obtaining the starting time information and offset information of all key frames in the TS segment; and
determining the starting time information and offset information corresponding to the key frame closest to the target position.

12. The electronic device according to claim 7, wherein an Android system is applied to the electronic device, and then receive the calling request from the application comprises:
receiving a serialized object from the application;
analyzing the serialized object to obtain the address parameter of the multi-media contents and the position parameter of the multi-media contents.

13. A non-transitory computer readable medium storing executable instructions that, when executed by an electronic device, cause the electronic device to:
receive a calling request from an application, wherein the calling request comprises the address parameter of multi-media contents and the position parameter of the multi-media contents;
acquire the multi-media contents starting from a target position corresponding to the position parameter from a server according to the address parameter;
play the multi-media contents starting from the target position.

14. The non-transitory computer readable medium according to claim 13, wherein the target position comprises a titles end position, and wherein the electronic device is further caused to:
send a position acquisition request to a server when receiving a play request from a user, wherein the position acquisition request comprises the address carried in the play request so that the server acquires the titles end position corresponding to the address from a pre-established mapping relationship between the address of the multi-media contents and the titles end position;
receive the titles end position which is fed back the server and is corresponding to the address.

15. The non-transitory computer readable medium according to claim 13, wherein the target position comprises an end position of the last played multi-media contents, and wherein the electronic device is further caused to:
find the end position of the last played multi-media contents from the play history when receiving the user's play request.

16. The non-transitory computer readable medium according to claim 13, wherein the multi-media contents comprise a steaming file, and wherein the electronic device is further caused to:
receive a time shifting command from a user in the process of playing a steaming file, wherein the time shifting command comprises a target position;
acquire the multi-media contents starting from a target position corresponding to the position parameter from a server according to the address parameter comprises:
determining and downloading a TS segment corresponding to the target position according to a segment index file according to the streaming file.
play the multi-media contents starting from the target position comprises:
determining the position information of a key frame, which is closest to the target position, in the TS segment; and
playing the TS segment according to the position information of the key frame.

17. The non-transitory computer readable medium according to claim 16, wherein determining the position information of a key frame, which is closest to the target position, in the TS segment, comprises:
analyzing the segment index file and obtaining the starting time information and offset information of all key frames in the TS segment; and
determining the starting time information and offset information corresponding to the key frame closest to the target position.

18. The non-transitory computer readable medium according to claim 13, wherein an Android system is applied to the electronic device, and then receive the calling request from the application comprises:
receiving a serialized object from the application;
analyzing the serialized object to obtain the address parameter of the multi-media contents and the position parameter of the multi-media contents.
